(19) United States
(12) Patent Application Publication
(10) Pub. No.: US 2018/0370830 A1
(43) Pub. Date: Dec. 27, 2018

(54) SYSTEM AND METHOD FOR CONTINUOUS PROCESSING OF ORGANIC WASTE WITH UNDIGESTED SOLIDS RECIRCULATION

(71) Applicant: Purpose Energy, Inc., Arlington, MA (US)

(72) Inventors: Eric Fitch, Arlington, MA (US); David M. O'Keefe, Gainesville, FL (US); Michael Ditton, Somerville, MA (US)

(73) Assignee: Purpose Energy, Inc., Arlington, MA (US)

(21) Appl. No.: 15/630,448

(22) Filed: Jun. 22, 2017

(51) Int. Cl. C02F 9/00; C02F 3/00; B01D 61/02; B01D 61/14; B01D 61/58

(52) U.S. Cl. CPC C02F 9/00; C02F 3/006; C02F 1/444; B01D 61/145; B01D 61/58; B01D 61/025

(57) ABSTRACT

Disclosed are methods and systems for minimizing downtime for waste processing plants by serially processing a potentially mixed waste stream including a solid fraction, low-strength wastewater, and/or high-strength wastewater in a plurality of anaerobic digesters (e.g., plug flow, upflow and fixed-film), and treating the processed liquid output with a plurality of tertiary wastewater treatments (e.g., ultrafiltration, reverse osmosis, precipitation), to produce a low suspended solids liquid and a high suspended solids liquid, and returning at least a portion of the high suspended solids liquid to the plurality of anaerobic digesters.

### FIELD OF THE INVENTION

The present invention relates to methods and apparatus for processing organic waste. More particularly, the present invention relates to methods and apparatus for processing food and beverage waste.

### BACKGROUND

Anaerobic digestion is a method used for converting industrial or municipal organic byproducts or substrates into clean and renewable energy in which microorganisms are used to break down biodegradable materials in the absence of oxygen. It is commonly used to treat wastewater and organic waste. Anaerobic digestion produces gases (e.g., methane) and nutrient-rich solids which can be recovered and used, e.g., in soil amendment (e.g., fertilizer.)

Commercial anaerobic digesters used at breweries typically do not digest suspended organic solids, such as spent grain, or high strength wastewater (spent yeast, trub, etc.). Digesters typically used at breweries are limited in application to waste that is substantially liquids containing soluble organics with chemical oxygen demand (“COD”) levels of about 5,000 ppm. However, breweries, and other food and beverage processing plants, also produce a variety of other waste streams with much higher COD concentrations, as well as high concentrations of suspended solids such as spent brewer's grains. There is, therefore, a need for anaerobic digester systems that are more capable in treating the full range of physical and chemical characteristics of food and beverage processing waste streams.

Anaerobic digestion can be a pretreatment step in the process of recycling water. Anaerobic digestion is used to remove the organic constituents of the wastewater and the mineral constituents and residual solids are removed through various tertiary processes including ultrafiltration and reverse osmosis (RO). These tertiary processes produce a clean permeate that will be recycled and a smaller volume of concentrate. This concentrate may contain particulate organic solids and high strength wastewater (high total dissolved solids RO concentrate) that must be removed from a treatment system, either by trucking, land application, sent to a publicly owned treatment works (POTW) plant, etc. since returning such waste to a digester may result in these constituents concentrating in the digester leading to solids build up and toxic concentrations of mineral constituents such as H₂S, NH₃, Na or other metals. Waste hauled offsite may often be used as a feed supplement for hogs and cattle. Problems arise if the utilized removal system is disrupted (e.g., if rainfall triggers permit levels preventing use of land application.) Rather than shutting down the waste treatment system, and thus halting the food and beverage manufacturing process, it would be useful to be able to return the concentrate to the waste process digester, at least until a toxicity limit is reached, potentially allowing uninterrupted food and beverage manufacturing. Furthermore, once the ability to remove concentrate is restored, it would also be useful to be able to reverse the concentration of mineral wastewater constituents by pumping ultrafiltration and RO permeate into the digester vessel. Hauling away or otherwise disposing of waste also limits the renewable energy production to about 5% of the potential renewable energy production that could be achieved if the high strength wastewater and organic solids were also efficiently anaerobically digested. Thus, what is needed are improved systems and methods for more efficiently treating both particulate solids and soluble organics as one, while increasing production uptime, reducing a manufacturing operations' carbon footprint, and reducing surcharge costs and dependencies on municipal water supplies.

### BRIEF DESCRIPTION OF THE DRAWING

The foregoing and other objects, features and advantages will be apparent from the following more particular description of the examples, as illustrated in the accompanying figures. The figures are not necessarily to scale, emphasis instead being placed upon illustrating the principles of the examples.

FIG. 1 is a process flow diagram of an anaerobic digestion resource recovery center for processing organic waste;

FIGS. 2A and 2B are schematic illustrations of a portion of a system for recirculating organic waste for use in conjunction with an anaerobic bioreactor; and

FIGS. 3A and 3B are schematic illustrations of a portion of a system for recirculating organic waste for use in conjunction with an anaerobic bioreactor.

### DETAILED DESCRIPTION

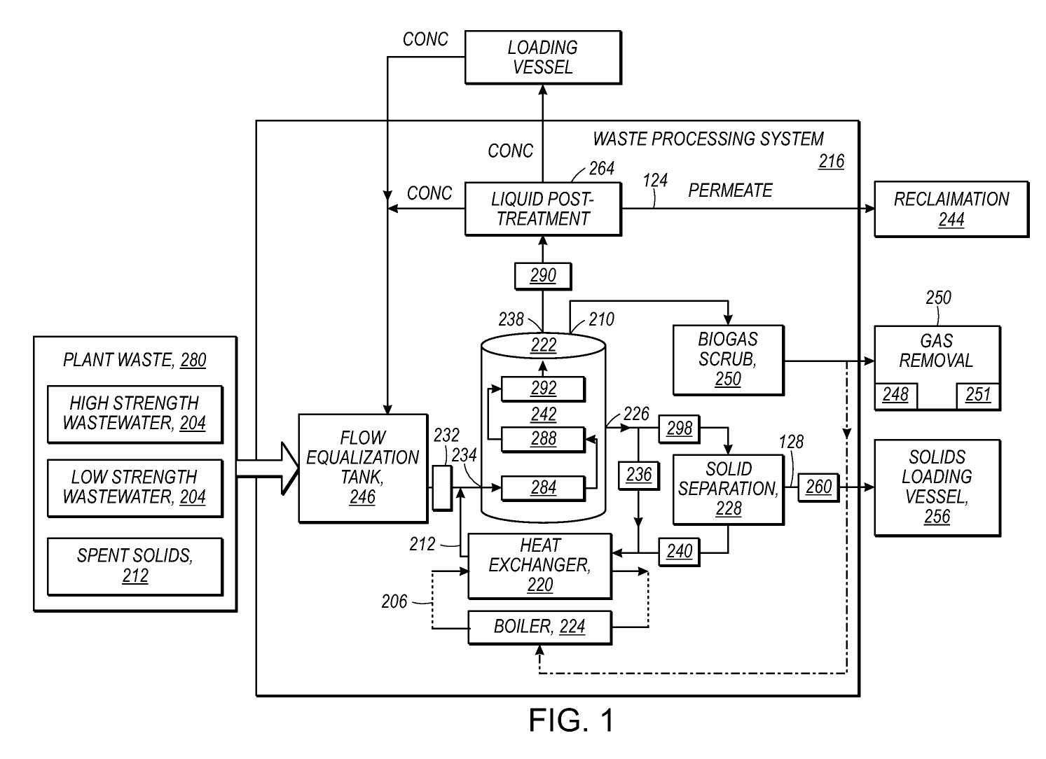

In one embodiment, an anaerobic organic waste treatment process and system are disclosed, as illustrated in FIG. 1, that utilize an anaerobic digester system 216 for processing organic waste. High strength (high COD) wastewater 204, low strength (low COD) wastewater 208 and organic waste solid fraction 212 such as spent grain, collectively waste 280, are provided to the system 216. As used herein, the terms “low strength” and “high strength” are meant to be interpreted consistent with the following description, which operationally distinguished high strength (high COD) and low strength (low COD) wastewater. Anaerobic digesters such as digester 216 can be designed based on an organic loading rate (OLR) for the system. For example, a digester may have a design OLR of 3.5 kg COD per liter of reactor volume per day. However, particulate solids require a minimum residence time to be solubilized and consumed by the bacteria present in the digester. If that minimum residence time is two days and an OLR from the above example of 3.5 kg COD/m3 results in a hydraulic residence time (HRT) of less than two days due to low organic strength of the wastewater, then the system is hydraulically constrained and the digester will need to be designed to accommodate at least two days of flow (2-day HRT). In this example, the incoming waste is considered “low strength” wastewater. Conversely, if the wastewater is of high enough organic strength that the design OLR of 3.5 kg COD/m3 results in an HRT of more than two days, then the wastewater is considered “high strength” wastewater. In this context, the distinction between high strength and low strength wastewater is not based on the absolute magnitude of the organic strength of the wastewater, but rather, is dependent on the design loading rate of the particular digester system. Low strength wastewater will use a hydraulic based design loading rate, high strength wastewater will use an organic load based loading rate.

The high strength wastewater 204, low strength wastewater 208 and organic waste solids 212 may be processed by the system 216 to produce gases, liquids and solids. The gases typically include a mixture of methane, carbon dioxide and some trace gases. The liquids have reduced concentrations of organic compounds and are sometimes discharged for subsequent processing by a POTW. The solids can be used as soil amendment materials. Soil amendment materials are materials that can be added to a soil as a nutrient (e.g., fertilizer) or to improve its physical properties (e.g., water retention, permeability, water infiltration, drainage, aeration and structure).

Any oxidizable material present in water (e.g., a natural waterway or in an industrial wastewater) will be oxidized both by biochemical (e.g., bacterial) or chemical processes. Since all natural waterways contain bacteria and nutrients, almost any waste compounds introduced into such waterways will initiate biochemical reactions. The biochemical reactions create what is measured as the biochemical oxygen demand (BOD). Oxidizable chemicals introduced into a natural waterway will similarly initiate chemical reactions. The chemical reactions create what is measured as the COD. Both the BOD and COD tests are a measure of the relative oxygen-depletion effect of a waste contaminant. The BOD test measures the oxygen demand of biodegradable pollutants and the COD test measures the oxygen demand of biodegradable pollutants plus the oxygen demand of non-biodegradable oxidizable pollutants.

In a non-limiting example, spent brewer's grains are a byproduct of a beer brewing process and consist essentially of boiled malted barley and typically have a COD greater than about 100,000 ppm. Spent brewer's grains are typically 20-30% solids with the remainder being liquid (e.g., water). Low strength wastewater 208 is typically created on the bottling line and in the brew house when the equipment is cleaned and typically has a COD approximately equal to or less than about 5,000 ppm. High strength wastewater typically includes spent yeast and trub (i.e., sediment which is mostly dead or inactive yeast that collects in the bottom of a beer fermentation vessel which is produced during the fermentation process) and typically has a COD between about 50,000 ppm and about 100,000 ppm. Beer bottoms and spent beer are also often included with high strength wastewater.

The high strength wastewater 204, low strength wastewater 208 and solids 212 are combined in a flow equalization tank 246. Combining the plant waste 280 in the flow equalization tank (FET) 246 transforms the plant's batch process into a quasi-continuous waste processing process. The combined waste (substrate) is pumped from the FET 246 to an inlet 234 of an anaerobic bioreactor 242 using a pump 232. The pump rate is controlled using the amount of substrate in the flow equalization tank as feedback to the pump speed. The pump speed may be increased as the FET 246 fills in order to prevent over filling of the FET 246. Similarly, the pump speed may be decreased as the FET 246 empties. At a predetermined level, the pump 232 shuts off. An example of the feedback algorithm used to control the operation of the pump 232 is a PID (proportional, integral, derivative) controller. Controlling the operation of the pump 232 results in a quasi-continuous process that is more continuous than the plant's batch process.

In one embodiment, the anaerobic bioreactor 242 is a three phase anaerobic digester. The anaerobic bioreactor 242 vessel 222 houses a plug flow digester 284, an upflow anaerobic sludge blanket digester 288, and a fixed-film anaerobic digester 292. In this embodiment, the plug flow digester 284, an upflow anaerobic sludge blanket digester 288, and a fixed-film anaerobic digester 292 are all integrated together into a single digester structure (i.e., vessel 222). An outlet of the plug flow anaerobic digester 284 is coupled to an inlet of the upflow anaerobic sludge blanket digester 288 via, for example, a conduit, tube or other suitable structure. An outlet of the upflow anaerobic sludge blanket digester 288 is coupled to an inlet of the fixed-film anaerobic digester 292 via, for example, a conduit, tube or other suitable structure. In some embodiments, one or more of the separate digesters are housed in separate vessels and then coupled together.

In some embodiments, an output of the plug flow anaerobic digester 284 is output the anaerobic bioreactor vessel 222 via outlet 226 to the solids separation module 228 and the liquid portion of the output of the solids separation module 228 is provided to the inlet of the upflow anaerobic sludge blanket digester 288. In some embodiments, an output of the upflow anaerobic sludge blanket digester 288 is output from the anaerobic bioreactor vessel 222 via outlet 226 to the solids separation module 228 and the liquid portion of the output of the of the solids separation module 228 is provided to the inlet of bioreactor 242.

The substrate (mixture of high strength wastewater 204, low strength wastewater 208 and spent solids 212) is provided to the plug flow anaerobic digester 284. In a plug flow anaerobic digester 284, organic material is introduced at an inlet and the material flows towards the outlet. The substrate, and in particular high concentration insoluble solids, flow slowly through the plug flow anaerobic digester 284 where they are broken down into soluble acids. The plug flow anaerobic digester 284 outputs a combination of solids, liquids and gases. The gas portion of the plug flow anaerobic digester 284 output is initially stored in the headspace of the anaerobic bioreactor vessel 222 for subsequent use and processing. The solids portion of the output of the plug flow anaerobic digester 284 is output from the anaerobic bioreactor vessel 222 via outlet 226 for additional processing or disposal. The liquid portion of the output of the plug flow anaerobic digester 284 (and some suspended solids) are provided to the upflow anaerobic sludge blanket digester 288 for additional processing. In one embodiment, the plug flow anaerobic digester 284 may be similar to the portion of the bioreactor described in U.S. Pat. No. 6,982,035 that includes, for example, an outer, high solids loop passage (the contents of U.S. Pat. No. 6,982,035 are hereby incorporated by reference).

The upflow anaerobic sludge blanket digester 288 processes the liquids received from the plug flow anaerobic digester 284 to produce an output comprising a combination of solids, liquids and gases. In one embodiment, the upflow anaerobic sludge blanket digester 288 also receives liquids from the solids separation module 228 which are processed to produce an output comprising a combination of solids, liquids and gases. The upflow anaerobic sludge blanket digester 288 forms a blanket of sludge which is suspended in the digester 288. The liquid portion of the output of the plug flow anaerobic digester 284 flows upwards through the blanket and is processed (degraded) by the anaerobic bacteria located in the upflow anaerobic sludge blanket digester 288. The degradation process produces the solids, liquids and gases. The gas portion of the plug flow anaerobic digester 284 output is initially stored in the headspace of the anaerobic bioreactor vessel 222, with the gas produced in other steps of the process, for subsequent use and processing. The solids portion of the output of the upflow anaerobic sludge blanket digester 288 is output from the anaerobic bioreactor vessel 222 via outlet 226 for additional processing or disposal. In some embodiments, the additional processing (e.g., processing with the solids separation module 228) produces a liquid portion that is directed to the inlet of the upflow anaerobic sludge blanket digester 288. The liquid portion of the output of the upflow anaerobic sludge blanket digester 288 (along with some suspended solids) is provided to the fixed-film anaerobic digester 292 for additional processing.

The fixed-film anaerobic digester 292 processes the liquids received from the upflow anaerobic sludge blanket digester 288 to produce an output comprising a combination of solids, liquids and gases. The fixed film anaerobic digester 292 has a significant amount of media that creates surface area on which methogenic bacteria grow a biofilm. As the bacteria metabolize organic material, they produce a biofilm. As the biofilm grows, it can detach and settle to the bottom of the vessel 222. In addition to the biofilm that forms on the fixed film media, unattached bacteria that form in the vessel can settle forming a sludge blanket. In addition, biofilm that detaches from the fixed film media and settles will augment the sludge blanket. The formation of the sludge blanket forms the upflow anaerobic sludge blanket (UASB) component of the system. It is important to be able to control the volume of the sludge blanket because if too much of it accumulates it will clog the media and prevent additional biofilm from detaching. In one embodiment, the media is suspended above the bottom of the vessel 222 and the volume of the sludge blanket is controlled by pumping a portion of the sludge blanket out of the vessel 222 via outlet 226 to the solids separation module 228. In some embodiments, the fixed-film anaerobic digester 292 is included in the portion of the bioreactor described in U.S. Pat. No. 6,982,035 that is the inner, low solids chamber.

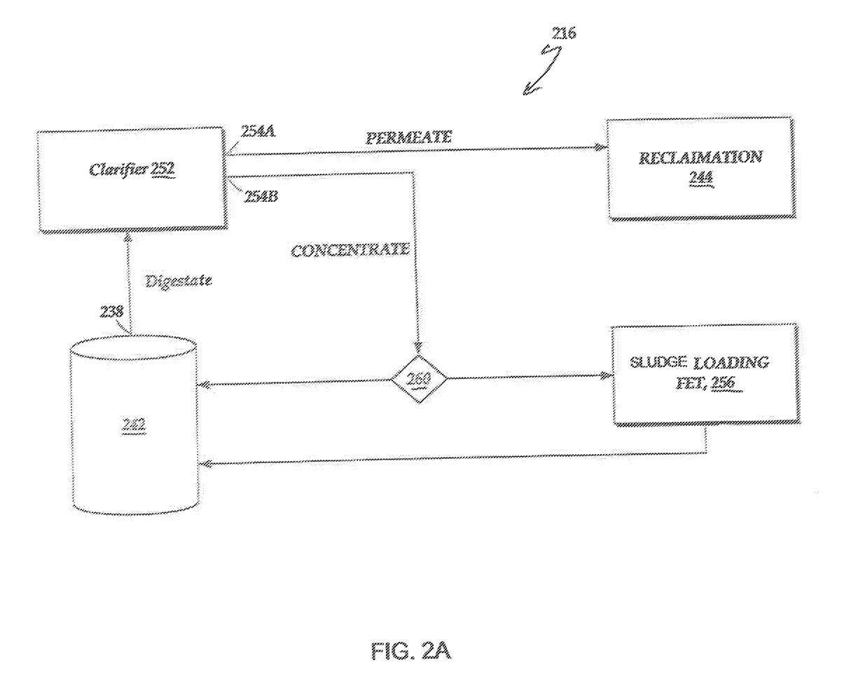

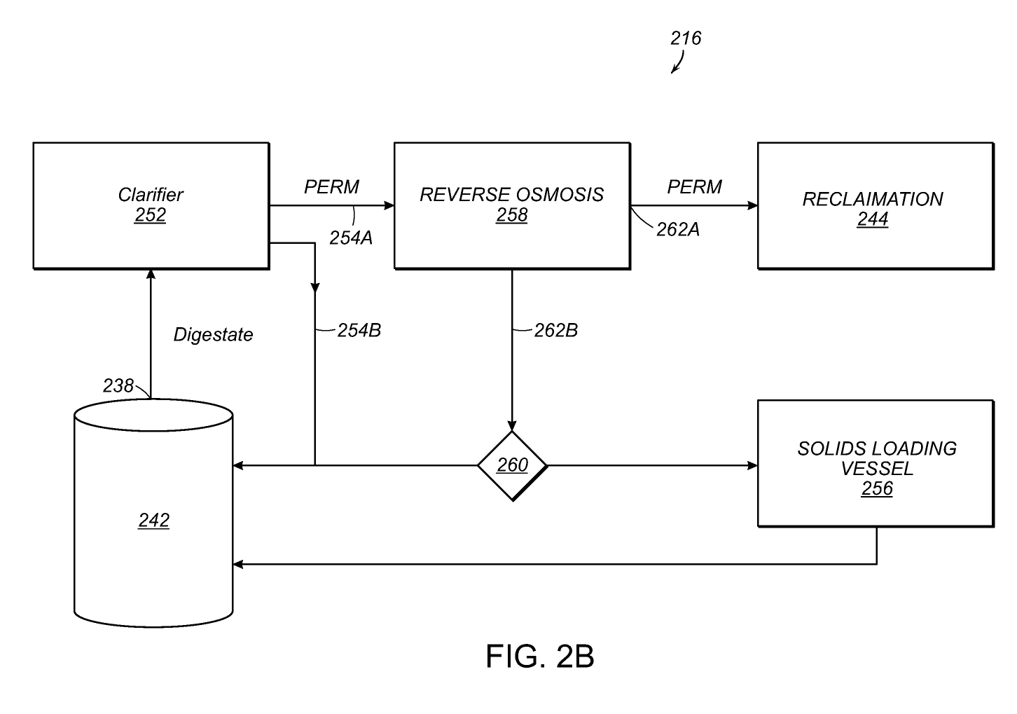

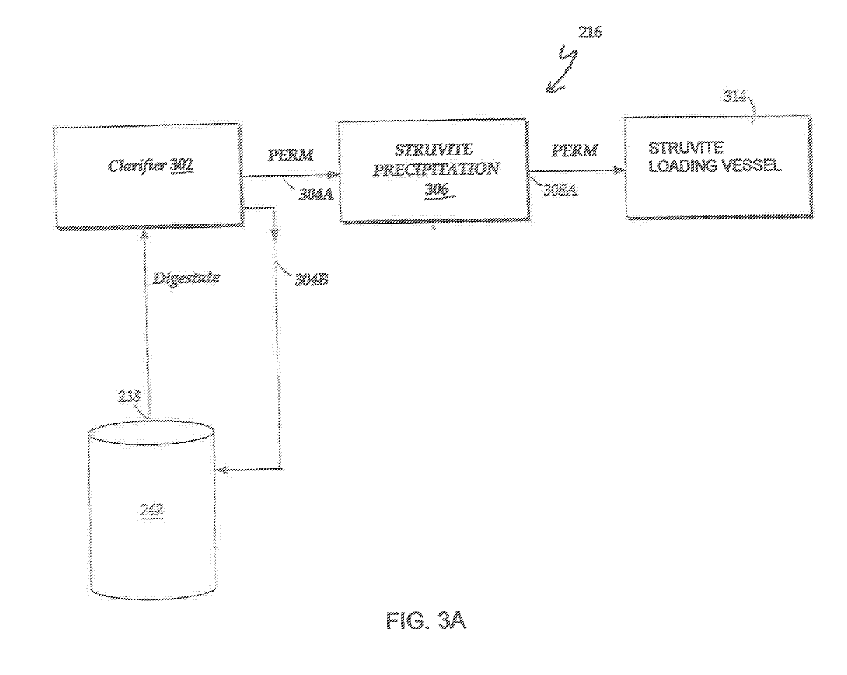

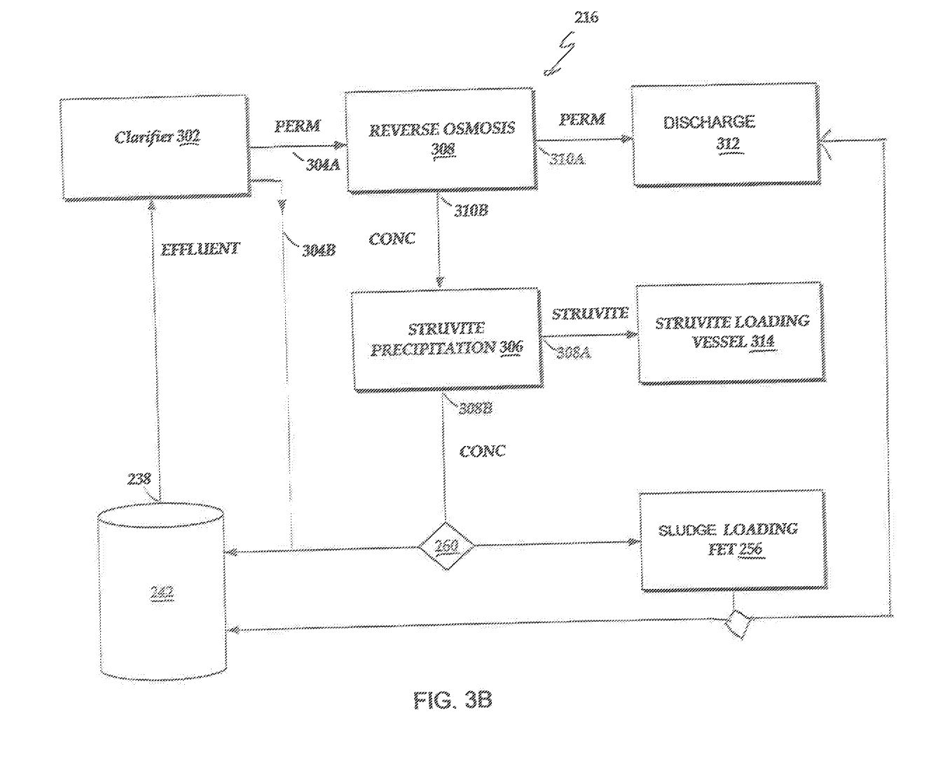

The gas portion of the fixed-film anaerobic digester 292 output is initially stored in the headspace of the anaerobic bioreactor vessel 222, with the gas produced in other steps of the process, for subsequent use and processing. The solids portion of the output of the fixed-film anaerobic digester 292 is output from the anaerobic bioreactor vessel 222 via outlet 226 for additional processing, as will be described below with reference to FIGS. 2A-2B and 3A-3B. A portion of the liquid portion of the output of the fixed-film anaerobic digester 292 is recirculated to the plug flow anaerobic digester 284.

Recirculating the liquid portion to the plug flow anaerobic digester 284 replenishes the bacteria used in the plug flow anaerobic digester 284. Another portion of the liquid portion of the output of the fixed-film anaerobic digester 292 is pumped out of outlet 238 of the vessel 222 with pump 290 to a liquid post treatment module 264. The rate of pumping is controlled with the volume of slurry in the anaerobic digester 242 as feedback (the volume of gas, organic fertilizer, and liquid effluent that is removed from the digester must be balanced with the volume of slurry that is added). The liquid post treatment module 264 may process the liquid and produce a liquid 124 that meets local discharge requirements.

In some embodiments, the liquid 124 may be provided to a reclamation unit 244, such as a POTW. In some embodiments, the liquid 124 is land applied (e.g., for irrigation). In some embodiments, the liquid post treatment module 264 includes an aerobic basin that reduces the oxygen demand of the liquid. In some embodiments, the liquid post treatment module 264 includes a flocculation process that causes remaining suspended solids to aggregate or clump together so the solids can be filtered from the discharge. In some embodiments, buffer materials are added to the liquid post treatment module 264 to bring the pH of the liquid 124 within acceptable levels.

The gases output from the anaerobic bioreactor 242 are provided to a biogas scrub module 250 via outlet 210. The gases are treated by a biogas scrubbing process. Moisture is removed from the gas. H₂S may be removed. CO₂ may be removed. The exact scrubbing process depends on the final use of the biogas. If the gas is to be used for combustion in a boiler, minimal scrubbing is required. If the gas is to be delivered to a natural gas distribution system (e.g., utility company), more scrubbing is required. Biogas that is produced accumulates in the headspace of the bioreactor 242 before it is output from the bioreactor 242. In some embodiments, the gas is first output to an optional, external auxiliary storage vessel (not shown). In some embodiments, biogas constituents are identified and quantified using a gas analyzer so the BTU of biogas delivered can be metered with a gas meter 248.

Any biogas produced that exceeds the storage capacity or collection capabilities of the system 216 is combusted in a flare device 251. The flare device 251 burns the excess gas (e.g., methane). The methane is converted to carbon dioxide and water before exhausting to the atmosphere, which is important because methane has more than twenty times the greenhouse gas effect compared to CO₂.

The gases produced by the anaerobic bioreactor 242 include predominantly methane gas with the balance being CO₂ gas and trace gases. Some moisture exists in the gas and this is typically removed with a condenser. If the concentration of H₂S, as a trace gas, is substantial (e.g., greater than about 1000 ppm) the H₂S may be reduced. H₂S will burn in a boiler or combustion engine, however, when it eventually is exhausted to the atmosphere it will oxidize and produce H₂SO₄ (sulfuric acid), which is corrosive. Several methods exist that are well known to those skilled in the art to reduce the H₂S concentration in the biogas. In some embodiments, the biogas scrub module 250 includes an activated carbon filtration system that sequesters the H₂S. In some embodiments, ferric chloride is introduced with the byproducts to prevent H₂S formation in the first place.

In one embodiment, a portion of the gas produced by the anaerobic bioreactor 242 is used in a boiler 224. The boiler 224 burns the gas to produce heat 206 that is used by the anaerobic bioreactor 242 in processing the plant waste 280. It is desirable to control the temperature of the anaerobic bioreactor 242 to optimize the metabolism of the anaerobic bacteria. A heat exchanger 220 receives heat from the boiler 224. The heat 206 from the boiler 224 heats liquid received from the anaerobic bioreactor 242 (through pump 236) and/or the solids separation module 228. The heated liquid 212 is then output from the heat exchanger 220 to the inlet 234 of the vessel 222 of the anaerobic bioreactor 242. The heated liquid 212 is used in the anaerobic digestion processes that occur in the vessel 222 of the anaerobic bioreactor 242. In some embodiments, the boiler 224 is a plant boiler used in the plant for other purposes (e.g., the beer brewing process or heating the facility). In some embodiments, the boiler 224 is a dedicated boiler used exclusively for the anaerobic digester system 216.

If the entirety of the biogas produced by the bioreactor 242 is not consumed by the food and/or beverage processes and the boiler 224, then the excess gas can be sold to a gas utility for subsequent distribution to gas customers. Gas that is to be provided to a gas utility requires the moisture, H₂S and CO₂ to be removed from the biogas. There are various technologies available for removing these substances from the gas which are well known to those skilled in the art. For example, skid mount units are commercially available that remove these substances from the biogas (e.g., the NEO-Gas™ plant sold by New Energy Solutions, Inc. of Pittsfield, Mass.). In some embodiments, the excess gas is converted to electricity using a generator set that consumes the excess gas, or heat and electricity using a cogeneration system. In some embodiments, the gas is compressed and stored. In some embodiments, the excess gas is combusted in the flare device 251.

Solids produced by the anaerobic bioreactor 242 are pumped to the solids separation module 228. The anaerobic bioreactor 242 pumps solids to the solids separation module 228 with pump 298. In one embodiment, the solids separation module 228 includes a screw press that wrings water from the solids and produces a soil amendment material 128 that is pumped to a solids loading vessel 256 via conveyer 260. The soil amendment material 128 is trucked offsite. The liquid that is wrung from the solids is pumped back to the anaerobic bioreactor 242 using pump 240. In some embodiments, the liquid pumped by the pump 240 is mixed with the liquid that is circulated through the heat exchanger 220 and then into the inlet 234 of the bioreactor vessel 222.

FIGS. 2A and 2B illustrate additional embodiments of waste processing system 216, which achieve higher efficiency through tertiary treatment and recirculation of solids that were not digested in the first flow through bioreactor 242. The embodiments include means for selectively diluting levels of toxin in the bioreactor 242, functioning like a kidney, by adding RO and/or ultrafiltration permeate to recirculating components returned to the bioreactor 242 continuously, or when measured levels of toxins in the bioreactor 242 exceed predetermined thresholds. Anaerobic digestate pumped out of outlet 238 may contain several things, including biomass, solid COD material, soluble COD material, and nutrients. Ideally, the biomass and COD materials are returned to the bioreactor 242. Returning the biomass to the digester increases the density of the biomass inside the bioreactor vessel, which ultimately results in a more volume efficient bioreactor because the mass of COD that a bioreactor can consume is proportional to the mass of the biomass, not the volume of the bioreactor.

The anaerobic digestate leaving anaerobic bioreactor 242 immediately enters a clarifier 252, which may comprise a gravity clarifier (although anaerobic biomass is notorious for poor settling characteristics), a lamella plate clarifier, a cyclone separator, a dissolved air floatation clarifier (DAF), ultrafiltration, or the like. Ultrafiltration at 0.04 micron pore size has been shown to maintain a high flux after anaerobic digestion with negligible fouling or increase in transmembrane pressure.

Clarifier concentrate 254B, which may contain high suspended solids, may be recirculated back to the anaerobic bioreactor, directly or through a FET 256. Concentrate 254B may possess a total suspended solids (TSS) of about 10,000 mg/L or more. Use of valve 260 and FET 256 assist in maintaining continuous operation in waste processing system 216 with minimal down time.

Clarifier permeate 254A, which may include low suspended solids (e.g., a TSS of about 200 mg/L or less), may be pumped to reclamation unit 244, or (as shown in FIG. 2B) may be first treated using RO system 258 to produce a low total solids liquid permeate 262A and a high dissolved solids liquid concentrate 262B. The RO low total solids liquid permeate 262A can then be reused by reclamation unit 244. Reuses may include use in POTW, or as CIP clean-in-place, boiler feed, chiller feed, or other process water uses that generated the initial wastewater flow. This reuse will reduce the total volume of water required for and wastewater generated by the process water processes. The RO low total solids liquid permeate 262A may also have a low Langelier Saturation Index (LSI), which could result in corrosion of metal pipes and vessels, so remineralization may be required for compatibility with contacted materials. It may also be necessary to degas the effluent to remove any dissolved biogas that can cause odor or flavor.

One approach to treating both the soluble and suspended solids in a single anaerobic digester is to decouple the solids retention time (SRT) from the hydraulic retention time (HRT) by creating separate chambers within a single tank with a geometry that retains suspended solids in the vessel while passing soluble organics downstream through the reactor. Another approach to achieving the goal of decoupling the SRT from the HRT is to remove suspended solids from the digester effluent using a solids separation technology such as a clarifier, ultrafiltration, or other device and returning the separated suspended solids to the reactor vessel. RO high dissolved solids liquid concentrate 262B may be recirculated back into anaerobic bioreactor 242, directly or through valve 260 and FET 256. The high dissolved solids liquid 262B may include a plurality of components toxic to the bacteria contained within the plurality of anaerobic digesters above certain concentrations. The concentration of these components within the anaerobic bioreactor 242 may be monitored, and recirculation of the high dissolved solids liquid back to the anaerobic digesters may be stopped (with valve 260) while the concentration(s) remain above the threshold concentration(s), but maintained when the concentration of each of the plurality of toxic components is less than their respective threshold concentrations. This will allow for the management of dissolved constituents in the digester liquid to avoid plant shutdowns when removal of concentrates from the wastewater system is not possible, and will allow for the mitigation of toxic concentrations of wastewater constituents. This provides a new and novel management tool for the treatment and recycling of wastewater.

An aerobic digester (not shown) may additionally treat the clarifier permeate 254A prior to subsequent processing and or use. This digester may be used to remove any soluble BOD/COD from the clarifier permeate 254A, to form any precipitates that may occur due to oxidation and/or to the change in pH that results from stripping dissolved carbon dioxide from the clarifier permeate.

Struvite can pose a problem in waste treatment, particularly after anaerobic digesters solubilize ammonium and phosphate from waste material. Struvite can form a scale on lines and belts, in centrifuges and pumps, clog system pipes and other equipment including the anaerobic digester itself. Struvite forms when there is a mole to mole to mole ratio (1:1:1) of magnesium, ammonia and phosphate in the wastewater. Struvite is more likely to form in a high pH environment, where there is higher conductivity, lower temperatures, and higher concentrations of magnesium, ammonia and phosphate. Having struvite scale in a waste treatment system can lead to great inefficiency within the plant or operation due to clogging of the pipes, pumps and equipment. Thus, recovery of phosphorus from waste streams as struvite and recycling those nutrients would be beneficial.

FIGS. 3A and 3B illustrate an aspect of an embodiment of system 216 that treats the bioreactor digestate for struvite and recirculates the treated waste flow. The bioreactor digestate 238 are pumped to clarifier 302, where solids are removed. Clarifier concentrate 304B, which may contain high suspended solids, may be recirculated back to the anaerobic bioreactor 242. The clarifier permeate 304A (i.e., the liquid fraction) can then be further treated. For example, a struvite precipitation processor 306 can be inserted to harvest the nitrogen and phosphorus (e.g., Ostara Pearl Process) from the clarifier permeate 304A and precipitation concentrate 308A may then be pumped to struvite loading vessel 314. Alternatively a coagulant can be used to precipitate nutrients prior to the clarifier 302, so that they are recycled to the bioreactor 242 and will ultimately enrich the biosolids that are harvested from the digester(s) in bioreactor 242. For example, ferric chloride can be used to precipitate phosphorus into iron phosphate, which is beneficial in dewatered solids as a plant nutrient. The clarifier permeate 304A can undergo an Anammox treatment process that is more efficient at removing nitrogen than traditional biological treatment (e.g., World Water Works and/or Paques.)

A RO system 308 may produce from the clarifier permeate 304A a low total solids liquid permeate 310A and a high dissolved solids liquid concentrate 310B. The RO low total solids liquid permeate 310A may be sent to discharge 312. Struvite can also be precipitated at precipitation unit 306 from the RO concentrate 310B. In accordance with the advantageous operational features described above, the struvite precipitator concentrate may be recycled back to bioreactor 242, when predetermined toxic thresholds are not being exceeded (i.e., the kidney-like feature). If the thresholds are being exceeded in bioreactor 242, the precipitation concentrate 308B may be directed by valve 260 to FET 256 and/or sent to discharge 312.

Those of ordinary skill would readily appreciate that numerous variations in the described implementations may be possible.

“Comprise,” “include,” and/or plural forms of each are open ended and include the listed parts and can include additional parts that are not listed. “And/or” is open ended and includes one or more of the listed parts and combinations of the listed parts.

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

What is claimed is:

1. A method for processing waste, comprising:
receiving a waste stream comprising at least one of a solid fraction, low-strength wastewater, and high-strength wastewater;
serially processing the waste stream within each of a plurality of anaerobic digesters resulting in a processed output liquid;
treating the processed liquid output with a plurality of tertiary wastewater treatments to produce a low suspended solids liquid and a high suspended solids liquid; and
returning at least a portion of the high suspended solids liquid to the plurality of anaerobic digesters.

2. The method of claim 1, wherein the low suspended solids liquid possesses a TSS of about <200 mg/L and the high suspended solids liquid possesses a TSS of about >10,000 mg/L.

3. The method of claim 1, wherein the plurality of anaerobic digesters are selected from the group consisting of plug flow anaerobic digesters, upflow, sludge-bed anaerobic digesters, and fixed-film anaerobic digesters.

4. The method of claim 1, wherein the tertiary treatment comprises ultrafiltration producing an ultrafiltration permeate and an ultrafiltration concentrate.

5. The method of claim 4, wherein the ultrafiltration permeate is the low suspended solids liquid.

6. The method of claim 4, wherein the ultrafiltration concentrate is the high suspended solids liquid.

7. The method of claim 4, wherein the tertiary treatment further comprises reverse osmosis of the ultrafiltration permeate producing a low total solids liquid and a high dissolved solids liquid.

8. The method of claim 7, wherein the reverse osmosis permeate comprises a low total solids liquid.

9. The method of claim 7, wherein the reverse osmosis concentrate is the high dissolved solids liquid.

10. The method of claim 4, wherein the tertiary treatment further comprises precipitation of struvite from the ultrafiltration permeate.

11. The method of claim 7, wherein the tertiary treatment further comprises precipitation of struvite from the reverse osmosis concentrate.

12. The method of claim 7, wherein a portion of the high dissolved solids is recirculated to the plurality of anaerobic digesters, the portion being non-toxic to the bacteria contained within the plurality of anaerobic digesters.

13. The method of claim 7, wherein the high dissolved solids liquid comprises a plurality of components toxic to the bacteria contained within the plurality of anaerobic digesters at respective threshold concentrations and wherein the method further comprises:
monitoring the concentrations of each of the plurality of toxic components within the plurality of anaerobic digesters;
halting recirculation of the high dissolved solids liquid with the plurality of anaerobic digesters while the concentration of at least one of the toxic components within the plurality of anaerobic digesters is greater than its threshold concentration; and
maintaining recirculation of the high dissolved solids liquid within the plurality of anaerobic digesters while the concentration of each of the plurality of toxic components within the plurality of anaerobic digesters is less than their respective threshold concentrations.

14. A system for processing waste, comprising:
at least one inlet for receiving a waste stream comprising at least one of a solid fraction, a low-strength wastewater, and a high-strength wastewater;
a plurality anaerobic digesters arranged in series, wherein a first digester of the plurality of digesters is adapted to receive the waste stream and wherein a last digester of the plurality of digesters outputs a liquid processed from the waste stream;
a plurality of tertiary wastewater treatment modules arranged in series and adapted to perform tertiary wastewater treatment, wherein a first tertiary treatment module is adapted to receive the processed liquid, wherein a last tertiary module outputs a low total solids liquid, and wherein one or more of the plurality of tertiary modules outputs a high dissolved solids liquid; and
a recirculation pathway adapted to direct at least a portion of the high dissolved solids liquid into the plurality of anaerobic digesters.

15. The system of claim 14, wherein the low total solids liquid possesses a total solids of about <200 mg/L and the high dissolved solids liquid possesses a total dissolved solids of about >2000 mg/L.

16. The system of claim 14, wherein the plurality of anaerobic digesters are selected from the group consisting of plug flow anaerobic digesters, upflow anaerobic digesters, and fixed-film anaerobic digesters.

17. The system of claim 14, wherein the high dissolved solids liquid is not toxic to the bacteria contained within the plurality of anaerobic digesters.

18. The system of claim 14, wherein the high dissolved solids liquid comprises a plurality of components toxic to the bacteria contained within the plurality of anaerobic digesters at respective threshold concentrations and wherein the system further comprises:
a plurality of sensors adapted to monitor the concentration of respective ones of the plurality of toxic components within the plurality of anaerobic reactors;
means for selectively diluting the concentration of the plurality of toxic components exceeding a predetermined threshold;
a valve positioned within the recirculation pathway, wherein the valve is adapted to:
maintaining recirculation of the high dissolved solids liquid with the plurality of anaerobic digesters while the concentration of each of the plurality of toxic components within the plurality of anaerobic digesters measured by the plurality of sensors is less than their respective threshold concentrations;
halt recirculation of the high dissolved solids liquid with the plurality of anaerobic digesters while the concentration of at least one of the toxic components within the plurality of anaerobic digesters measured by the plurality of sensors is greater than its threshold concentration.

19. The system of claim 14, wherein the plurality of tertiary treatment modules comprises an ultrafilter producing an ultrafiltration permeate and an ultrafiltration concentrate.

20. The system of claim 19, wherein the ultrafiltration permeate comprises the low suspended solids liquid.

21. The system of claim 19, wherein the plurality of tertiary treatment modules further comprises a reverse osmosis module adapted to produce a reverse osmosis permeate and a reverse osmosis concentrate.

22. The system of claim 21, wherein the reverse osmosis permeate is the low total solids liquid.

23. The system of claim 21, wherein the high dissolved solids liquid comprises at least one of the ultrafiltration permeate and the reverse osmosis concentrate.

24. The method of claim 19, wherein the plurality of tertiary treatment modules further comprises a struvite precipitation module adapted to receive the ultrafiltration permeate and output struvite precipitated from the ultrafiltration permeate and the low suspended solids liquid.

25. The method of claim 21, wherein the plurality of tertiary treatment modules further comprises a struvite precipitation module adapted to receive the reverse osmosis concentrate and output struvite precipitated from the osmosis concentrate and the high dissolved solids liquid.
